(19) United States
(12) Patent Application Publication
(10) Pub. No.: US 2007/0081872 A1
(43) Pub. Date: Apr. 12, 2007

(54) Milling cutter head and a milling cutter tool

(75) Inventors: Per Blomstedt, Gavle (SE); Ralf Lehto, Gavle (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB

(21) Appl. No.: 11/540,958

(22) Filed: Oct. 2, 2006

(30) Foreign Application Priority Data
Oct. 5, 2005 (SE) 0502204-1

(51) Int. Cl. B23C 5/00

(52) U.S. Cl. 409/234

(57) ABSTRACT

A replaceable milling cutter head, which has an external envelope surface having a rotationally symmetrical basic shape in respect of a central axis. The cutter head includes a plurality of peripherally spaced-apart cutting edges and chip flutes, and two axially spaced-apart, front and rear ends. An axial hole extends all the way through a frame of the cutter head. The milling cutter head has a flat, pulley-like basic shape, such that the axial distance between the two ends thereof is at most half as large as the greatest outer diameter thereof. A hollow space for receiving a male element of a basic body is recessed in the rear end of the milling cutter head. The cross-section area of the hollow space, in a plane perpendicular to the center axis, amounts to at least 25% of the total cross-section area of the milling cutter head, as determined by the outer diameter.

This application claims priority under 35 U.S.C. § 119 to Swedish Patent Application No. 0502204-1, filed on Oct. 5, 2005, the disclosure of which is incorporated by reference herein in its entirety.

### FIELD OF THE INVENTION

The present invention relates generally to a replaceable milling cutter head, which has, on one hand, an external envelope surface, which has a rotationally symmetrical basic shape in respect of a central axis, and includes a plurality of peripherally spaced-apart cutting edges and chip flutes, and, on the other hand, two axially spaced-apart, front and rear ends, an axial hole extending all the way through a frame of the same, the milling cutter head having a flat, pulley-like basic shape, such that the axial distance between the two ends is at most half as large as the greatest outer diameter thereof. The invention also relates to a milling cutter tool having such a milling cutter head.

### BACKGROUND OF THE INVENTION

Within the field of milling machining of, in particular, metallic workpieces, a plurality of proposals of milling cutter tools have recently been made, the milling cutter heads of which are made in a single piece of cemented carbide, the requisite cutting edges being formed in the proper cemented carbide body (contrary to such cutting edges that are included in separate cemented-carbide inserts, which individually are detachably mounted on a milling cutter head of steel). Such milling cutter heads of cemented carbide having integrated cutting edges are commonly denominated loose tops, in particular when they are included in small milling cutters, such as shank-end mills, contour mills and the like. Examples of milling cutter tools that make use of such loose tops are found in the following patent documents: WO 03/097281, WO 03/101650, EP 0911101, EP 1237670, EP 1342521, DE 3230688, U.S. Pat. No. 6,241,433, U.S. Pat. No. 6,276,879, U.S. Pat. No. 6,494,648 and U.S. Pat. No. 6,497,540.

The majority of previously known milling cutter heads of cemented carbide, which are assembled from a rotatable and frequently cylindrical basic body, have an elongate shape, such that the axial extension of the milling cutter head is larger than the diameter thereof, as well as a male-like fastening member that projects rearward from the rear end of the milling cutter head, in order to be possible to be inserted into a female-like seat in a free, front end of the basic body. This generally elongate shape of the milling cutter head has, among other things, the consequence of subjecting the tool to considerable bending loads in the interface between the rear end of the milling cutter head and the front end of the basic body, because the predominant radial cutting forces act on the free, front end of the milling cutter head. Furthermore, the generally elongate shape entails the disadvantage that the means for transferring torques from the basic body to the milling cutter head, for geometrical reasons, cannot be made with anything else but a very limited radial extension. In other words, the torque arm for the transfer of torque becomes limited, and the contact surfaces between the two components small. In this connection, it should be mentioned that such tools that solely rely on threaded joints for the transfer of torque are quite objectionable. Another disadvantage of previously known milling cutter heads is that the consumption of the expensive cemented carbide material in the manufacture becomes comparatively large in relation to the number of active cutting edges on the same. In addition, the cutting edges will frequently be formed along at least the major part of the axial length of the milling cutter head and at times the entire length, in spite of the cutting edges in many applications being utilized only along a smaller part of the length thereof. Thus, in fine milling, for instance, it occurs that only 1-10% of the entire edge length become worn, while 90-99% remain unutilized.

The present invention aims at obviating the above-mentioned disadvantages of previously known milling cutter tools and at providing an improved milling cutter tool having an improved milling cutter head. Therefore, an object of the invention, in a first aspect, is to provide a milling cutter head that, on one hand, can be fixed in a stable and exact way on the basic body of the tool, and on the other hand has an interface acting against the basic body via which interface considerable torques can be transferred from the basic body to the milling cutter head, without the same skidding or being dislodged from the desired position thereof.

Another object of the invention is to provide a milling cutter head having a geometry that allows the formation of a large number of cutting edges located close to each other as well as the appurtenant chip flutes. In an embodiment, the invention aims at providing a milling cutter head that is particularly suitable for milling at small cutting depths, such as in fine milling. In other words, the milling cutter head should be possible to be made without unnecessary long and costly cutting edges.

Yet another object of the invention is to provide a cemented carbide milling cutter head that is simple and inexpensive to manufacture by means of known manufacturing methods, e.g., compression-moulding and sintering, more precisely under the utilization of minimal amounts of expensive material. In this connection, the milling cutter head should also be possible to be finished in a simple way.

In another aspect, the invention also relates to a milling cutter tool, which in the assembled state includes a milling cutter head as well as a rotatable basic body. An object in this respect is to provide a milling cutter tool, the interface of which between the basic body and the milling cutter head is formed in such a way that the fixation of the milling cutter head in the desired position becomes reliable, stable and exact in a repeatable way. Another object of the invention is to provide a milling cutter tool, the milling cutter head of which does not run the risk of coming loose from the basic body as a consequence of failing holding functions.

### SUMMARY OF THE INVENTION

In an embodiment, the invention provides a replaceable milling cutter head, which has an external envelope surface having a rotationally symmetrical basic shape in respect of a central axis. The cutter head includes a plurality of peripherally spaced-apart cutting edges and chip flutes, and two axially spaced-apart, front and rear ends. An axial hole extends all the way through a frame of the cutter head. The milling cutter head has a flat, pulley-like basic shape, such that the axial distance between the two ends thereof is at most half as large as the greatest outer diameter thereof. A hollow space for receiving a male element of a basic body is recessed in the rear end of the milling cutter head. The cross-section area of the hollow space, in a plane perpendicular to the center axis, amounts to at least 25% of the total cross-section area of the milling cutter head, as determined by the outer diameter.

In another embodiment, the invention provides a milling cutter tool including a rotatable basic body and a replaceable milling cutter head, which has an external envelope surface having a rotationally symmetrical basic shape in respect of a central axis. The cutter head includes a plurality of peripherally spaced-apart cutting edges and chip flutes, and two axially spaced-apart, front and rear ends. The cutter head has a flat, pulley-like basic shape, such that the axial distance between the two ends thereof is at most half as large as the greatest outer diameter thereof. The milling cutter head is connected to the basic body via a male element having means for the transfer of torque from the basic body to the milling cutter head. The milling cutter head is fixable on the basic body by means of a tightening device. A hollow space in which the male element engages is recessed in the rear end of the milling cutter head, an end surface thereof being urged against a bottom surface of the hollow space. The cross-section area of the hollow space and the male element respectively amounts to at least 25% of the total cross-section area of the milling cutter head, as determined by the outer diameter.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a partial perspective view of a milling cutter tool according to the invention composed of a basic body and a milling cutter head;

FIG. 2 is a perspective exploded view showing the basic body and the milling cutter head spaced-apart from each other and from a tightening device in the form of a screw;

FIG. 3 is an enlarged front plan view of only the milling cutter head;

FIG. 4 is a section A-A in FIG. 3;

FIG. 5 is a rear plan view of the cutter head;

FIG. 6 is a side view of the milling cutter head;

FIG. 7 is a section through the milling cutter head mounted on the basic body;

FIG. 8 is an exploded view of the components shown in FIG. 7;

FIG. 9 is a perspective view of an alternative milling cutter head according to the invention; and

FIG. 10 is an exploded view corresponding to FIG. 8 and showing the milling cutter head according to FIG. 9 together with the basic body and the tightening screw.

### DETAILED DESCRIPTION OF THE PREFERRED EMBODIMENTS

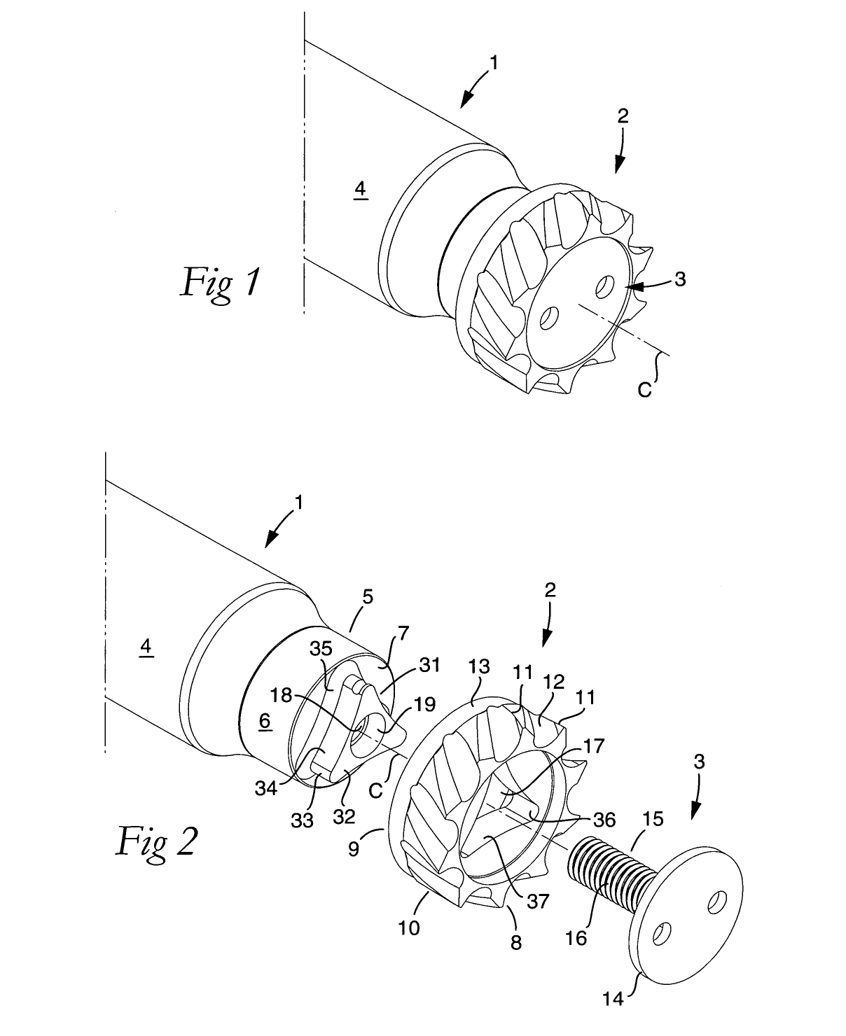

In FIGS. 1 and 2, a milling cutter tool made in accordance with the invention is shown, and which is composed of a rotatable basic body 1 and a replaceable milling cutter head 2. For the fixation of the milling cutter head on the basic body, a tightening device 3 is used, which in the embodiment shown is in the form of a front-mounted screw.

In the example, not only the milling cutter head 2, but also the basic body 1, has a rotationally symmetrical basic shape defined by a central axis C around which the tool is rotatable. Advantageously—though not necessarily—the basic body 1 has an elongate shape, and is, in this case, delimited along the major part of the length thereof by a cylindrical envelope surface 4. At the front, free end thereof, the basic body transforms into a thinner, male-like element or member 5, which is delimited by a rotationally symmetrical envelope surface 6, as well as a planar end surface 7. Most suitably, the envelope surface 6 is cylindrical.

The milling cutter head 2 has front and rear ends 8 and 9, respectively, between which a generally rotationally symmetrical envelope surface 10 extends. In the envelope surface, a plurality of peripherally spaced-apart cutting edges 11 are formed, between which there are chip flutes 12. Thus, although the envelope surface is not smooth, the same has, however, in respect of geometry, a rotationally symmetrical basic shape, which may be entirely or partly cylindrical, conical or arched. In the example shown, the edges extend 11 only along a part of the axial distance between the ends 8 and 9, a smooth, circumferential surface 13 being left between the set of cutting edges and the rear end 9 of the milling cutter head. Most suitably, the cutting edges are equidistantly spaced-apart along the circumference of the milling cutter head.

The screw 3 includes a head 14, as well as a shank 15 having a male thread 16. In is formed, through which the screw shank 15 can pass in order to be tightened in a female thread 18 in a central hole 19, which mouths in the front end of the basic body.

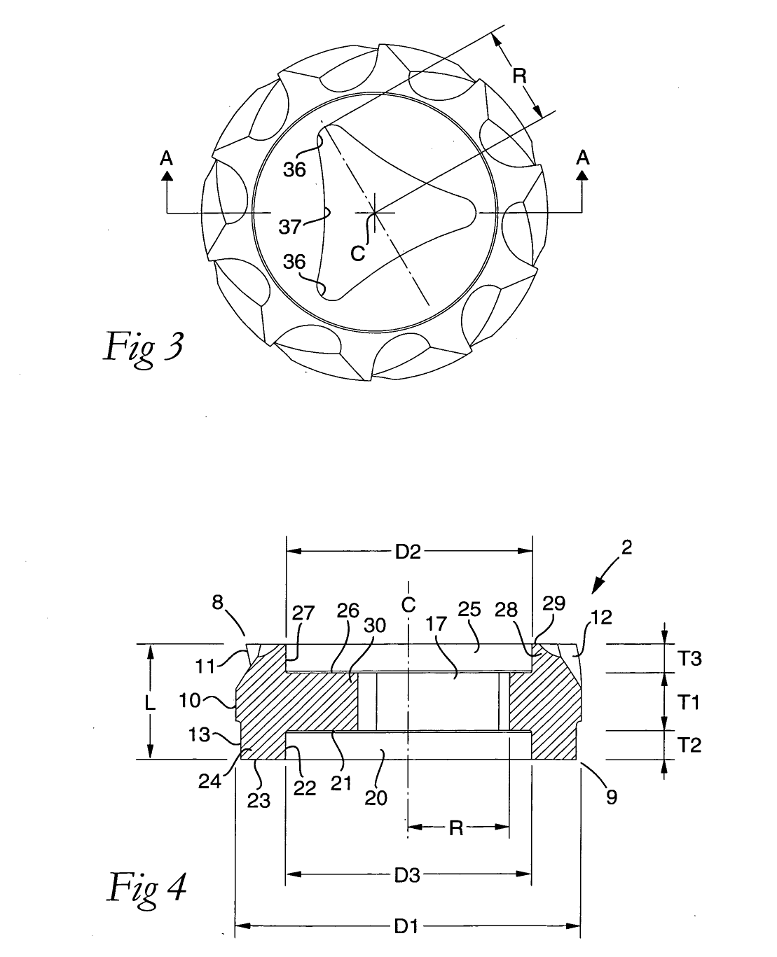

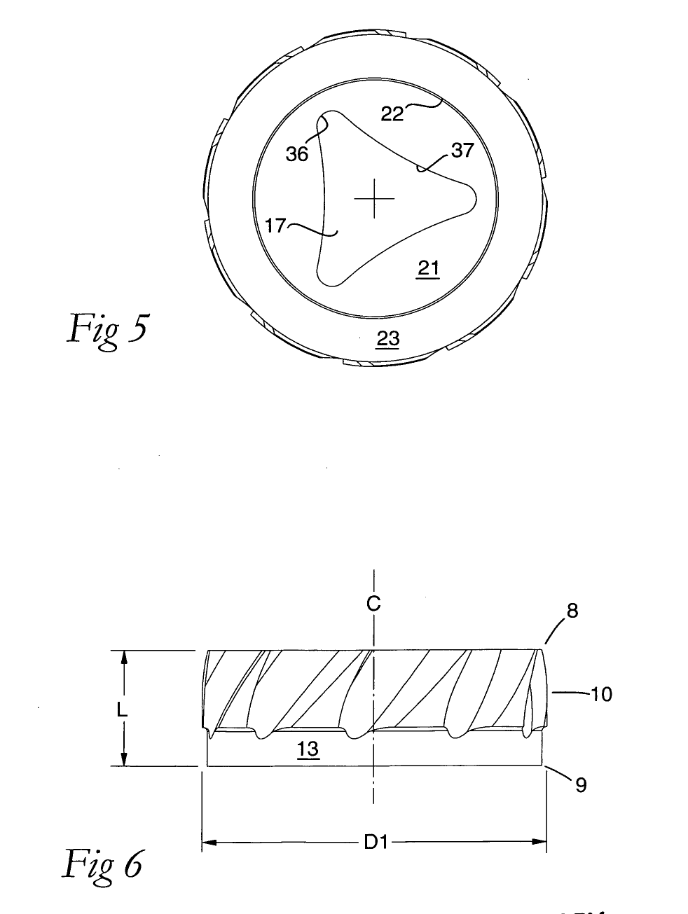

Reference is now made to FIGS. 3-8, which illustrate the milling cutter head 2 according to the invention. In the shown, preferred embodiment thereof, the milling cutter head is a body that is made in a single piece of a hard, wear-resistant material, such as cemented carbide, ceramics, cermet or the like. To that extent, the milling cutter head may be said to be composed of a hard, wear-resistant loose top, which is mountable on a basic body of a softer or more elastic material, in particular steel.

In the rear end 9 of the milling cutter head, a hollow space 20 opens, which is delimited by a bottom surface 21 and an endless circumferential limiting surface 22. Around the hollow space 20, a ring-shaped end surface 23 extends, which together with the limiting surfaces 13 and 22 delimits a ring- or rim-shaped part 24. In the preferred embodiment, the surface 22 is rotationally symmetrical, more precisely cylindrical, while the bottom surface 21 is planar and extends perpendicularly to the center axis C. Also the end surface 23 may advantageously be planar and smooth.

A second hollow space 25 opens in the front end 8 of the milling cutter head. In the same way as the first-mentioned hollow space, this hollow space 25 may be delimited by a planar bottom surface 26 and a rotationally symmetrical, suitably cylindrical limiting surface 27. Also surface 27 is formed on the inside of a ring-shaped part 28 of the milling cutter head. Ring part 28 is, however, directed forward and is axially delimited by a suitably planar front end surface 29.

In FIG. 4, D1 designates the greatest outer diameter of the milling cutter head, while L designates the length thereof, such as this is determined by the axial distance between the front and rear end surfaces 29 and 23, respectively. D2 designates the inner diameter of the front hollow space 25, while D3 designates the inner diameter of the rear hollow space 20. In the example shown, the two hollow spaces 20, 25 are made with one and the same diameter, something that is not necessary, however.

Characteristic of the milling cutter head according to the invention is that the same has a flat, pulley-like basic shape, such that the axial distance L between the two ends is at most half as large as the greatest outer diameter D1, at the same time as the cross-section area of the rear hollow space 20, in a plane perpendicular to the center axis C, amounts to at least 25% of the total cross-section area of the body, such as this is determined by outer diameter D1. In the example shown, the length L amounts to ⅓ (i.e., 33%) of the diameter D1. Within the scope of the invention, this ratio L/D1 may vary most considerably within the range below 0.5. However, it should not be below 0.15. In practice, a ratio L/DI within the range of 0.2-0.4, suitably 0.3-0.35, is preferred.

The cross-section area of the rear hollow space 20, in relation to the total cross-section area of the milling cutter head, is determined by the ratio between the diameters D3 and D1. In accordance with the invention, the hollow space 20 shall have an inner diameter D3 that amounts to at least 50% of the outer diameter D1. On the other hand, the inner diameter D3 should not exceed 85% of the outer diameter D1. In the example shown, the diameter D3 amounts to about 70% of the diameter D1.

It should be pointed out that, in the example, the ring-shaped part 24, which surrounds the rear hollow space 20, is equally thick along the entire circumference thereof, more precisely by the fact that the inner, cylindrical surface 22 is concentric with the external, likewise generally cylindrical envelope surface 10 (or the surface 13). Between the two planar bottom surfaces 21, 26, a material portion designated 30 is delimited, which forms a central frame or partition wall between the hollow spaces 20, 25. The thickness of said partition wall is designated T1, while the axial depths of the hollow spaces 20, 25 are designated T2 and T3, respectively. As is clearly seen in FIG. 4, the thickness of the partition wall 30 is greater than the depth of the individual hollow space 20, 25. In the embodiment, the depths T2, T3 of the hollow spaces are equally large. However, said depths may vary, provided that the front hollow space 25 is sufficiently deep to at least partly house the head 14 of the screw, and that a sufficiently long part of the front male element 5 of the basic body 1 should be able to engage the hollow space 20.

By the fact that the bottom surfaces 21, 26 are planar and mutually parallel, as well as extend perpendicularly to the center axis C, it follows that the partition wall 30 in its entirety extends in a plane perpendicular to the center axis.

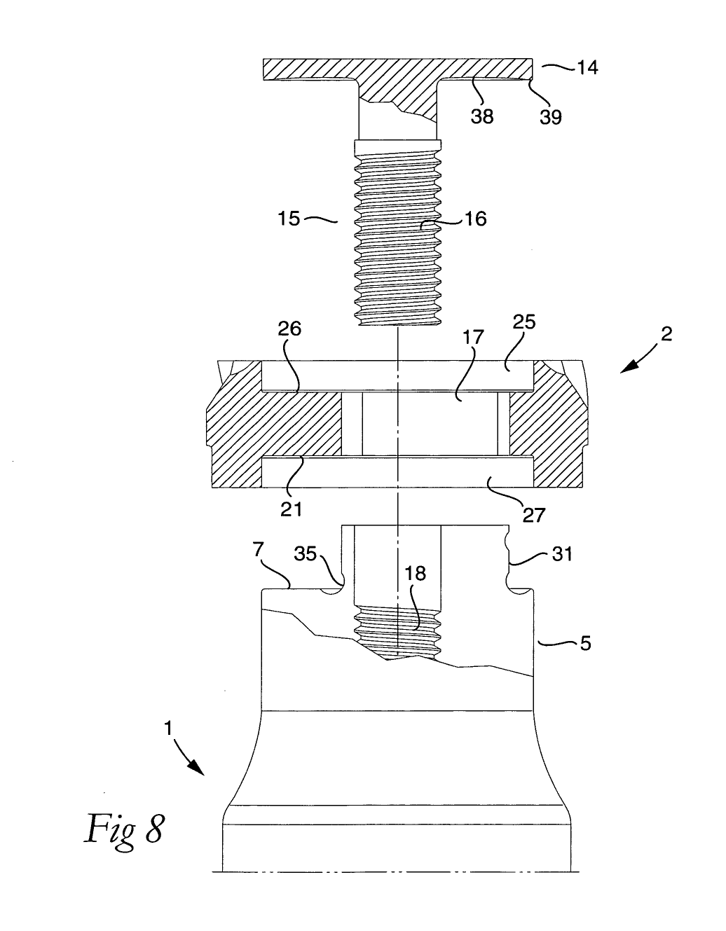

Now reference is made again to FIG. 2, which shows that a driver 31 is formed on the planar end surface 7 of the male element 5. Characteristic of said driver is that the same has an out of round cross-section shape as viewed in a plane perpendicular to the center axis. The out of round cross-section shape may in practice be realized in different ways. However, in the example, a generally triangle-like shape has been selected having three equidistantly (120°) spaced-apart tips or corners. More precisely, the driver 31 is delimited by a planar end surface 32, three convexly arched or rounded surfaces 33 at the three corners, as well as three concavely arched side surfaces 34 between the corners. Between the proper driver body and the end surface 7 of the male element 5, a narrowed waist 35 is formed (see also FIG. 8), which separates the inner edge of the side and comer surfaces 34, 33 of the driver from the end surface 7.

In the shown, preferred embodiment, the through hole 17 through the partition wall 30 is utilized as a female-like seat for the receipt of the driver 31. For this reason, in this case the hole 17 has been given a generally triangular shape corresponding to the triangular shape of the driver. The endless hole-edge surface that delimits the hole 17 includes therefore three concavely arched surfaces 36 located corner-wise, as well as three side surfaces 37 extending between the same and having an convexly arched shape. The fit between, on one hand, the surfaces 33, 34, and on the other hand the surfaces 36, 37, should be fine, e.g., within the range of 0.01-0.05 mm. For the sake of completeness, it should be pointed out that imaginary generatrices, which geometrically generate said surfaces, are parallel to the center axis C.

An emphasized feature of the described milling cutter head is that the driver 31 and the co-operating seat, i.e. the hole 17, has a considerable radial extension. In FIGS. 3 and 4, R designates the greatest radial extension of the seat 17, such as this is determined by the distance between the center axis C and the concavely arched corner surface 36 of the hole-edge surface. In the example shown, the radius R amounts to about 60% of the radius (D½) of the external envelope surface 10. This relatively large radial measure, which is enabled by the fact that the hollow space 20 has an even greater radius, guarantees that the torque arm for the transfer of torque from the basic body to the milling cutter head becomes advantageously large.

It should be pointed out that the means for the transfer of torque to the milling cutter head may be made in other ways than in the form of an out of round driver of the basic body and an out of round seat in the milling cutter head, and that it is not necessary to utilize the hole 17 as a seat. On the contrary, an object of the hole 17 is to allow the shank 15 of the screw 3 serving as a tightening device to pass through the milling cutter head 2 and be drawn into the basic body 1 during clamping of the milling cutter head. Against this background, it is feasible to give the hole 17 a conventional cylindrical shape, at the same time as the transfer of torque is provided in another way. For instance, one or more projections retreated radially from the center axis may be inserted into a corresponding number of seats, which open in the bottom surface 21. Conversely, it is feasible to form such projections on the bottom surface 21 at the same time as the requisite seats mouth in the planar end surface 7 of the basic body 1.

It is important for the stability of the milling cutter head on the basic body that the male member 5 protrudes a distance into the rear hollow space 20 in the milling cutter head 2, wherein the envelope surface 6 of the male member should have a fine fit (0.01 to 0.05 mm) against the inner limiting surface 22 of the hollow space. This means that the shown driver 31 could be spared, if the transfer of torque is provided in another way. In this connection, it should be pointed out that the surfaces contacting each other in the composed state of the tool, viz. the surface pairs 7, 21 and 6, 22, both have a radial extension that is considerable in relation to the outer diameter of the milling cutter head. This ensures that the fixation of the milling cutter head on the basic body becomes stable and reliable, also in case the tool is subjected to most varying combinations of axial and radial cutting forces.

Two other factors, both of which relate to the tightening screw 3, also contribute significantly to the stable fixation of the milling cutter head. In the embodiment shown in FIG. 2, the milling cutter head is right-hand cutting. Simultaneously, the screw 3 is right-threaded. This means that the screw upon tightening brings the milling cutter head to be angularly displaced (some hundredths of a millimeter) in such a way that the parts of the hole-edge surface 36, 37, against which torque is to be transferred from the corresponding part surfaces 33, 34 of the driver 31, are put in close contact to the same. Therefore, when the milling cutter head enters a workpiece, this takes place without the same rattling or moving vis-a-vis the basic body. The same effect is attained if the milling cutter head is left-hand cutting and the screw left-threaded.

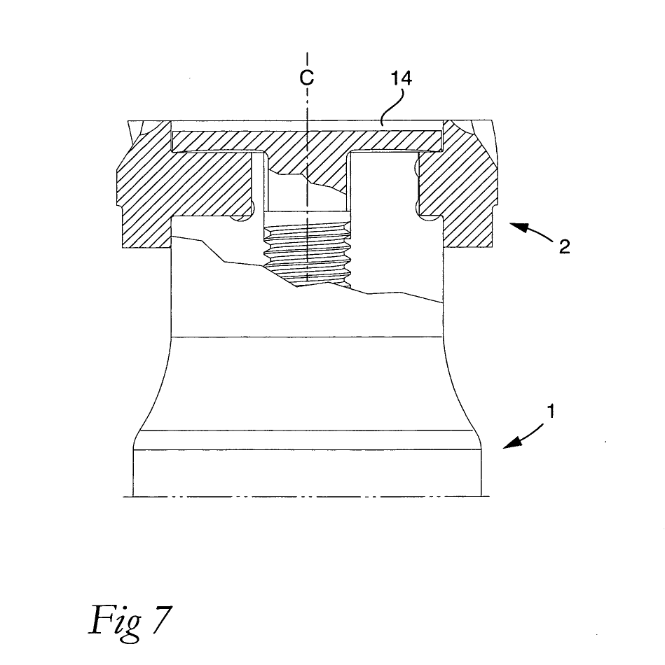

The second factor is illustrated in FIGS. 7 and 8, from which it is seen that the head 14 of the screw is in the form of a resilient brim having a diameter that is considerably greater than the thickness of the brim. Furthermore, on the underside thereof, the brim is formed with a concavely arched surface 38 so that only the circular periphery 39 thereof abuts against the bottom surface 26 of the front hollow space 25. When the screw is tightened in the female thread 18 of the basic body 1, the head or the brim 14 will be elastically deformed, and in such a way permanently apply a substantial spring bias to the milling cutter head. By the elastic flexibility of the brim, it is guaranteed that the milling cutter head is kept in place even if the tool would be subjected to vibrations or other outer stresses that aim to loosen the screw.

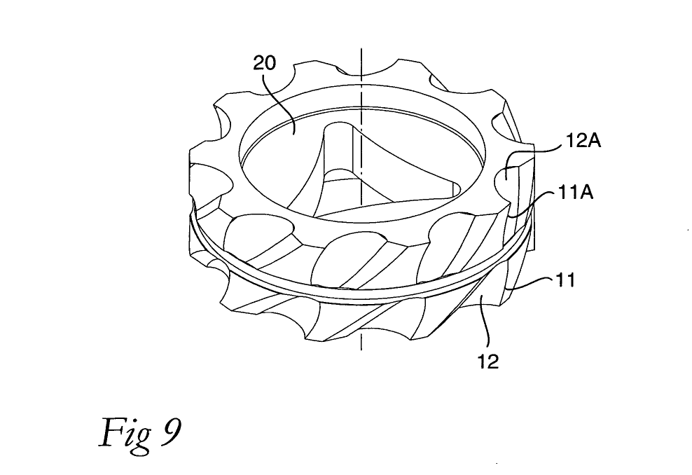

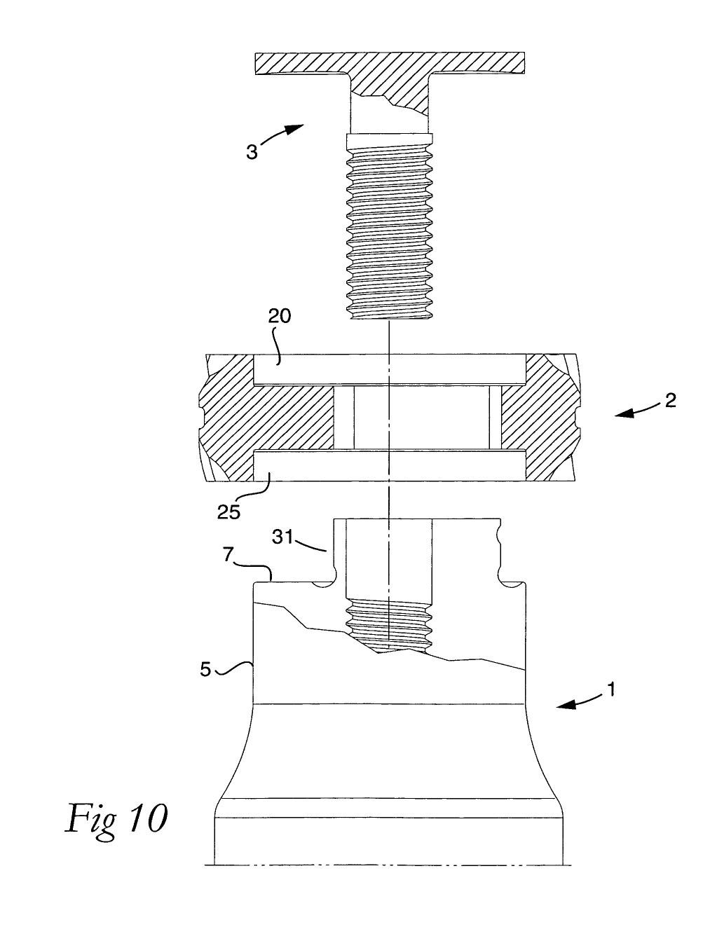

Reference is now made to FIGS. 9 and 10, which illustrate an alternative embodiment of the milling cutter head according to the invention. In this case, the two opposite hollow spaces 20, 25 are identical so far that they have the same depth and the same diameter. Furthermore, the external envelope surface is formed with two sets of cutting edges 11, 11A, (and appurtenant chip flutes 12, 12A). This means that one and the same milling cutter head becomes indexable to obtain the double service life, because the additional set of cutting edges 11A can be utilized when the cutting edges 11 have been consumed. Indexing of the milling cutter head takes place by the simple measures of loosening the fixing screw 3, indexing the milling cutter head, and again tightening the screw.

In U.S. Pat. No. 6,497,540 (more precisely in FIG. 8 of the document), a milling cutter head intended for contour milling is briefly shown, which has an axial length that per se is somewhat smaller than half of the outer diameter of the milling cutter head. Furthermore, the milling cutter head has a hollow space opening rearward for the co-operation with a projection on the appurtenant basic body. However, in this case, said hollow space is utmost small in respect of the depth thereof, as well as in respect of the diameter thereof. Thus, the diameter of the hollow space is just slightly greater than the diameter of the through hole through which a tightening screw passes. This means that the fixation of the milling cutter head on the basic body becomes unreliable, in particular as the milling cutter head lacks means for the transfer of torque from the basic body.

By the generally flat, pulley-like shape thereof in combination with the radially ample, hollow space for the receipt of the front end of the basic body, the milling cutter head according to the invention offers a number of advantages above previously known milling cutter heads. Thus, this basic shape offers the possibility of constructing the cutter head with a large number of cutting edges located close to each other, at the same time as the fixation of the cutter head on the rotatable basic body becomes very stable and exact, since, on one hand, the planar contact surfaces have a large radial extension, and on the other hand the rotationally symmetrical contact surfaces are situated at a large radial distance from the center axis. Furthermore, by the fact that the rear hollow space has a large radial extension, the possibility of constructing the tool with driver members is offered, which in turn are radially far retreated from the center axis; something which in turn ensures that large torques can be transferred from the basic body to the milling cutter head by means of moderate forces in the interfaces between the contact surfaces. In the indexable embodiment thereof according to FIGS. 9 and 10, the invention has the additional advantage that two different sets of cutting edges can be utilized, something which is particularly attractive in connection with milling at small or moderate cutting depths, such as in fine milling or the like.

While the invention has been disclosed with reference to certain preferred embodiments, numerous modifications, alterations, and changes to the described embodiments are possible without departing from the sphere and scope of the invention, as defined in the appended claims and their equivalents thereof. For example, as has been indicated above, it is feasible to form one or more projections on the bottom surface in the rear hollow space of the milling cutter head, and allow the same projections to co-operate with holes or seats in the planar end surface of the basic body. Important for the stability of the milling cutter head is that the front portion of the basic body projects a distance into the rear hollow space of the milling cutter head, and not whether the means for the transfer of torque are one or more male-like members placed on the basic body and co-operating with seats in the milling cutter head. Furthermore, in this connection, it should be pointed out that the transfer of torque also may be provided by the fact that the circumferential contact surface 6 of the basic body, which co-operates with the inner, endless contact surface 22, is made with an out of round, e.g., polygonal shape, at the same time as the surface 22 is given a complementary shape. Furthermore, for the fixation of the milling cutter head on the basic body, it is feasible to use other tightening devices than a screw having a male thread. Thus, a drawbar without a thread may be used, which is drawn into the basic body by other suitable means, e.g., an eccentric mechanism or the like. Also such a drawbar may, however, advantageously be constructed with a resilient head of the type included in the shown tightening screw. Accordingly, it is intended that the invention not be limited to the described embodiments, but that it have the full scope defined by the language of the following claims.

What is claimed is:

1. A replaceable milling cutter head, which has an external envelope surface having a rotationally symmetrical basic shape in respect of a central axis, and includes a plurality of peripherally spaced-apart cutting edges and chip flutes, and two axially spaced-apart, front and rear ends, an axial hole extending all the way through a frame of the cutter head, the milling cutter head having a flat, pulley-like basic shape, such that the axial distance between the two ends thereof is at most half as large as the greatest outer diameter thereof, wherein a hollow space for receiving a male element of a basic body is recessed in the rear end of the milling cutter head and that the cross-section area of the hollow space, in a plane perpendicular to the center axis, amounting to at least 25% of the total cross-section area of the milling cutter head, as determined by the outer diameter.

2. The milling cutter head according to claim 1, wherein the hollow space is delimited by a bottom surface in which the axial hole mouths, as well as an endless limiting surface on the inside of a ring-shaped part of the cutter head, at least one female seat mouthing in the bottom surface for the receipt of a male driver.

3. The milling cutter head according to claim 2, wherein the seat defines an out of round cross-section shape.

4. The milling cutter head according to claim 2, wherein the axial hole through the frame has an out of round cross-section shape and forms the female seat.

5. The milling cutter head according to claim 2, wherein the ring-shaped part is generally equally thick along the entire circumference thereof, such that the inner, endless limiting surface is rotationally symmetrical and concentric with the envelope surface of the cutter head.

6. The milling cutter head according to claim 5, wherein the endless limiting surface is cylindrical.

7. The milling cutter head according to claim 2, wherein an axial hole-edge surface in the seat and maximally retreated radially from the center axis is situated at a radial distance from the center axis that amounts to at least 50% of the greatest outer radius of the cutter head.

8. The milling cutter head according to claims 2, comprising a second hollow space that opens in the front end.

9. The milling cutter head according to claim 2, wherein the end surface of the head that surrounds the hollow space is in the form of a planar, ring-shaped surface, which extends in a plane perpendicular to the center axis.

10. The milling cutter head according to claim 8, wherein the frame defines as a flat partition wall between the hollow spaces, and extends in a cross-plane perpendicular to the center axis.

11. The milling cutter head according to claim 10, wherein a thickness of the partition wall is greater than an axial depth of each individual hollow space.

12. A milling cutter tool comprising a rotatable basic body and a replaceable milling cutter head, which has an external envelope surface having a rotationally symmetrical basic shape in respect of a central axis, and includes a plurality of peripherally spaced-apart cutting edges and chip flutes, and two axially spaced-apart, front and rear ends and which has a flat, pulley-like basic shape, such that the axial distance between the two ends thereof is at most half as large as the greatest outer diameter thereof, the milling cutter head being connected to the basic body via a male element having means for the transfer of torque from the basic body to the milling cutter head, the milling cutter head being fixable on the basic body by means of a tightening device, wherein a hollow space in which the male element engages is recessed in the rear end of the milling cutter head, an end surface thereof being urged against a bottom surface of the hollow space, the cross-section area of the hollow space and the male element respectively amounts to at least 25% of the total cross-section area of the milling cutter head, as determined by the outer diameter.

13. The milling cutter tool according to claim 12, wherein the male member of the basic body has a rotationally symmetrical cross-section shape, and has an end surface in which a hole mouths having a female thread co-operating with a male thread of a screw serving as a tightening device.

14. The milling cutter tool according to claim 12, wherein on the end surface of the male member, at least one driver is formed, which engages a seat in the milling cutter head.

15. The milling cutter tool according to claim 13, wherein the cutting edges of the milling cutter head are right-hand cutting and the screw simultaneously right-threaded so that the screw upon tightening should press adequate contact surfaces in the seat against torque-transferring contact surfaces of the driver.

16. The milling cutter tool according to claim 13, wherein the cutting edges of the milling cutter head are left-hand cutting and the screw simultaneously left-threaded so that the screw upon tightening should press adequate contact surfaces in the seat against torque-transferring contact surfaces of the driver.

17. A replaceable milling cutter head, symmetrically disposed about a longitudinal central axis, comprising:
a plurality of peripherally spaced-apart cutting edges and chip flutes;
front and rear ends axially spaced by a distance that is at most half the distance of the greatest outer diameter of the cutter head;
a hole extending from the rear end to the front end of the cutter head; and
a hollow space recessed in the rear end for receiving a male element of a basic body, a cross-sectional area of the hollow space, in a plane perpendicular to the central axis, being at least 25% of the total cross-sectional area of the milling cutter head, as determined by the outer diameter.
